(19) United States
(12) Patent Application Publication
(10) Pub. No.: US 2017/0245348 A1
(43) Pub. Date: Aug. 24, 2017

(54) COMMUNICATION SYSTEM FOR ADAPTIVE LIGHTING CONTROL

(71) Applicant: GENERAL ELECTRIC COMPANY, SCHENECTADY, NY (US)

(72) Inventor: Tamás Both, Budapest (HU)

(21) Appl. No.: 15/581,224

(22) Filed: Apr. 28, 2017

Related U.S. Application Data
(63) Continuation of application No. 14/132,174, filed on Dec. 18, 2013, now abandoned.

(51) Int. Cl. H05B 37/02

(52) U.S. Cl. CPC H05B 37/0227; H05B 37/0281

(57) ABSTRACT

Provided is a lighting system to control illumination of a plurality of areas. The lighting system includes a lighting fixture matrix having a plurality of lighting fixtures respectively located at the plurality of areas. Each of the lighting fixtures includes a sensor and a controller coupled with the sensor, a first sensor being configured to detect the presence of a user in a first of the plurality of areas. The lighting system also includes a communication circuit configured to provide for communication between each of the plurality of lighting fixtures. Upon detection of presence of a user in the first area, the respective controller is configured to illuminate a first of the lighting fixtures and send a signal to simultaneously trigger illumination of two or more of a remaining number of the plurality of areas.

### I. RELATED APPLICATION

This application is a continuation under 37 CFR 1.53 of copending, commonly-owned U.S. application Ser. No. 14/132,174, filed 18 Dec. 2013, which is hereby incorporated by reference in its entirety.

### II. TECHNICAL FIELD

The present invention relates to lighting. More particularly, the present invention relates to lighting systems that adapt to compensate for a user's movement within an illuminated area.

### III. BACKGROUND

In large geographic regions, it is often desirable to provide a control system for the lighting in the building or outdoor space in order to reduce energy costs. Currently, lighting areas such as a corridor or room, can be controlled by various means such as from a central location, by remote control, or by motion detection. Centrally located lighting control systems can require the integration of sensors and lighting drivers into a dedicated analogue/digital/communications system such as can be implemented by the digital addressable lighting interface (DALI) protocol.

Additionally, lighting in an area can be controlled by a remote control, but this requires user input as well, and is also not automatic. Thus, energy savings are not likely to be great. Motion sensors can also be used to control lighting in an area to save energy, but such a system can be characterized by abrupt on and off cycles that do not provide continuous light to an area where a user is present, such as when the user is at the border of the detection area of one of the motion sensors.

Manufacturers of conventional lighting systems are attempting to mitigate the abrupt on and off cycles noted above, and provide continuous light only to areas where the user is present. These attempts, however, fail to address a remaining fundamental challenge. For example, even if motion sensing lighting systems can provide continuous light only to specific areas where the user is present, these systems cannot compensate for variations in the speed at which the user moves from one detection area to other detection areas. That is, if the user abruptly changes direction or moves in excess of a certain speed, he/she will eventually exceed the system's ability to provide light coverage. Consequently, the user will move into darkened areas.

### IV. SUMMARY OF THE EMBODIMENTS

Given the aforementioned deficiencies, a need exists for methods and systems that adapt to changes in the direction and speed of the user's movement and dynamically adjust the lighting coverage in response to these changes. A need also exists for adaptive lighting methods and techniques that can be implemented in existing lighting systems.

In at least one embodiment, the present invention provides a lighting system to control illumination of a plurality of areas. The lighting system includes a lighting fixture matrix having a plurality of lighting fixtures respectively located at the plurality of areas. Each of the lighting fixtures includes a sensor and a controller coupled with the sensor, a first sensor being configured to detect the presence of a user in a first of the plurality of areas. The lighting system also includes a communication circuit configured to provide for communication between each of the plurality of lighting fixtures. Upon detection of presence of a user in the first area, the respective controller is configured to illuminate a first of the lighting fixtures and send a signal to simultaneously trigger illumination of two or more of a remaining number of the plurality of areas

In the illustrious embodiments of the present invention, a luminaire network is constructed with wiring between individual luminaires being more easily implemented. Every luminaire in the system need only be connected to its neighbors, with a transmitted sensing signal reaching every other luminaire in the network. If a lamp transmits a message onto the network, the neighboring luminaires automatically pass it to their neighbors, this way spreading emotion information across the entire luminaire network.

The illustrious embodiments, a connection line facilitating communication between luminaires can be, for example, four wires, two for transmitting signals, and other two to receive signals. These wires can be optically isolated to avoid a ground loop. Using this method for communication between the luminaires, the luminaires in the system can be installed in factory state, without a need for set up during the installation. In the factory state, the system will be able to operate properly upon installment. A luminaire sensing motion can notify other luminaires of the event. The receiver luminaires determine the distance from the sensing luminaire through evaluating a motion sensing signal and acting in response thereto.

Further features and advantages, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### V. BRIEF DESCRIPTION OF THE DRAWINGS

Exemplary embodiments may take form in various components and arrangements of components. Exemplary embodiments are illustrated in the accompanying drawings, throughout which like reference numerals may indicate corresponding or similar parts in the various figures. The drawings are only for purposes of illustrating preferred embodiments and are not to be construed as limiting the invention. Given the following enabling description of the drawings, the novel aspects of the present invention should become evident to a person of ordinary skill in the art.

FIG. 1 is a block diagram of a lighting fixture of a lighting control system according to an exemplary embodiment of the present disclosure.

FIG. 2 is a side view of a lighting system configured for an occupancy scenario according to an exemplary embodiment of the present disclosure.

FIG. 3 is a top view of a lighting system based on a second occupancy scenario according to an exemplary embodiment of the present disclosure.

FIG. 4 is a side view of a hypothetical occupancy scenario in view of the lighting system illustrated in FIG. 2.

FIG. 5 is an exemplary illustration of a single row of interconnected luminaires constructed in accordance with an embodiment of the present invention.

FIG. 6 is an exemplary illustration of a lighting luminaire matrix constructed in accordance with the embodiments.

FIG. 7 is an timing diagram of an exemplary timing scheme associated with the exemplary lighting luminaire matrix of FIG. 6.

FIG. 8 is a flow chart 800 of an exemplary method of practicing an embodiment of the present invention.

### VI. DETAILED DESCRIPTION OF THE EMBODIMENTS

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

Unless defined otherwise, technical and scientific terms used herein have the same meaning as is commonly understood by one of ordinary skill in the art to which this disclosure belongs. The terms “first,” “second,” and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean either, any, several, or all of the listed items.

The use of “including,” “comprising,” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect. The terms “circuit,” “circuitry,” and “controller” may include either a single component or a plurality of components, which are either active and/or passive components and may be optionally connected or otherwise coupled together to provide the described function.

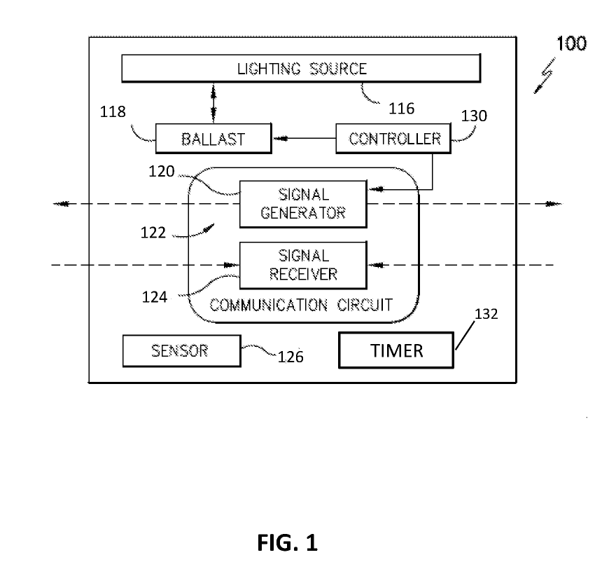

FIG. 1 depicts a single lighting fixture 100 that can be used as part of a broader lighting system (discussed below) for dynamic lighting control according to an exemplary embodiment of the present disclosure. The lighting fixture (e.g., luminaire) 100 has a lighting source 116, a sensor 126, a ballast 118, a controller 130, a signal generator 120, and a signal receiver 124. The signal generator 120 and signal receiver 124 can each be a part of a communication circuit with nearby luminaires (not shown).

The lighting source 116, for example, can be instant on and can be a fluorescent tube, a white light emitting diode (LED), an LED array that combines white and red LEDs, a combination of fluorescent tubes and LEDs. The luminaire could also include other suitable lighting sources, such as high intensity discharge lamps, including ceramic metal halide lamps, or any other suitable lighting source.

The sensor 126 is used to determine if a user is located in a detection area corresponding to the sensor so that the illumination of the lighting source can be triggered or initiated. The sensor 126 can be a motion sensor or an occupancy sensor. Motion sensors respond to walking or other movements. Motion sensors can perceive movements in the selected detection zone and respond to them.

A lighting source 116 can be controlled to turn on upon detection of movement by the motion sensor. The lighting source 116 can be controlled switches that turn off after no movement is detected for a period of time. The use of motion detectors or sensors can be preferable for detecting moving objects outdoors or in corridors indoors, where there is more likely to be constant movement that is detected.

The sensor 126 can also be an occupancy sensor. Occupancy sensors detect the presence of a user in an area instead of detecting movements. Thus, occupancy sensors can be more effective in areas such as offices where the user is more sedentary, as opposed to areas such as corridors where more movement is occurring.

Numerous types of occupancy sensors exist, including passive infrared (PIR) occupancy sensors, active ultrasonic occupancy sensors, dual-technology passive infrared and active ultrasonic occupancy sensors, dual-technology passive infrared and microphonic occupancy sensors, and other suitable sensors.

A technical effects associated with embodiments of the invention is that such an arrangement provides sufficient illumination but can save significant energy because remote areas are not lit. Another technical effect is that when the user moves through a space having multiple luminaires that detect the user's presence and/or movement and communicate with each other, the lit area can follow the user.

The luminaire 100 can also include a ballast 118 to regulate the power provided to the lighting source 116. In general, ballasts stabilize the current through an electrical load to provide the proper power to the lighting source. The ballast 118 can be used to ensure the proper current is provided to power fluorescent lamps, high-intensity discharge lamps, or other lamps used as lighting source 116.

The controller 130 controls illumination of the luminaire through control of the ballast. Upon receipt of a signal from the sensor 126 indicating the presence of a user in a detection area, the controller 130 can send a signal to the ballast 118 and/or lighting source 116 to trigger illumination of the lighting source 116. The controller 130 can be any suitable control device, such as a microcontroller, processor, control circuit, or other suitable control device. A timer 132, formed of any suitable timing circuit, provides a time base for operation of the controller 130, and other components within the luminaire 100.

As shown in FIG. 1, the luminaire 100 can also include a communication circuit 122. The communication circuit 122 can include a signal generator 120 and a signal receiver 124. The signal generator 120 can be its own, dedicated component and can be used to send a signal to a second luminaire to trigger the illumination of the second luminaire.

In particular, the controller 130, which illuminates the luminaire 100 upon the detection of the presence of a user by the sensor 126, can also control the signal generator to send a signal to a nearby second luminaire to trigger its illumination. The signal generator 120 can send an optical, infrared, ultrasonic, radio frequency, or hard-wired signal to the second luminaire. The signal receiver 124 of FIG. 1 is used to receive signals generated from signal generators associated with other luminaires in the area. Upon receipt of a signal from another luminaire, the controller 130 can illuminate the lighting source 116.

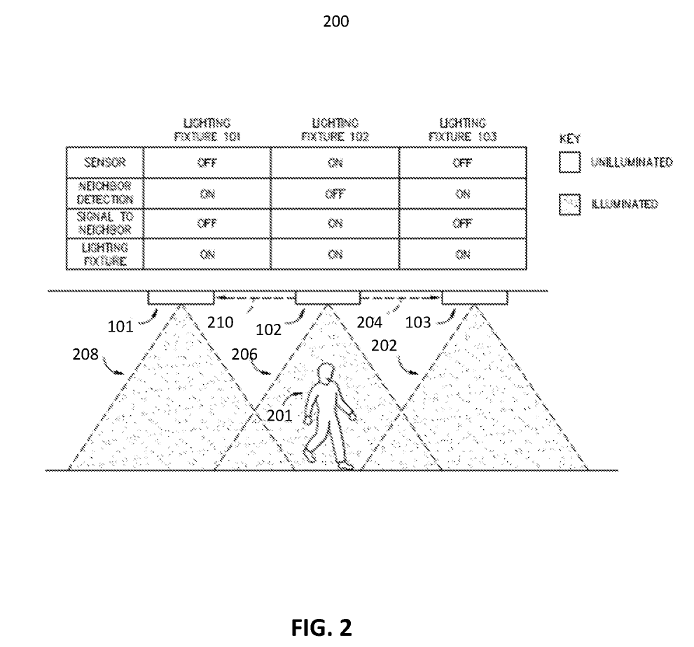

FIG. 2 depicts a side view of a broader lighting system 200 based on a specific occupancy scenario in accordance with the embodiments. By way of example, a user 201 is standing under a luminaire 102, which corresponds to sensor detection area or view angle 206. Because the sensor associated with the luminaire 102 has detected a user in its detection area, the controller associated with luminaire 102 triggers the illumination of its lighting source. Note that the user 201 is not present in view angle/detection area 208 or view angle/detection area 202, so luminaires 101 and 103 are not illuminated based on the presence of the user 201 in their respective detection areas.

The sensor associated with luminaire 102 is on, however, due to the presence of the user 201 in detection area or view angle 206. Thus, the controller associated with the luminaire 102 initiates the generation of a motion sensing notification signal 210 that is sent to luminaire 101, while a motion sensing notification signal 204 is generated and sent to luminaire 103. Both luminaires 101 and 103 are configured to communicate with luminaire 102 via a communication circuit.

Although neither sensor associated with luminaire 101 or 103 is on, because no user is present in their view angles of 208 and 202, respectively, the motion sensing notification signals 210 and 204, sent from luminaire 102, trigger the illumination of both luminaires 101 and 103. Thus, the user 201 is surrounded by light on each side of the luminaire 102 under which the user stands, which provides for a comfortable environment, while also saving energy. Luminaires too far away from luminaire 102 to be controlled remain off or unlit.

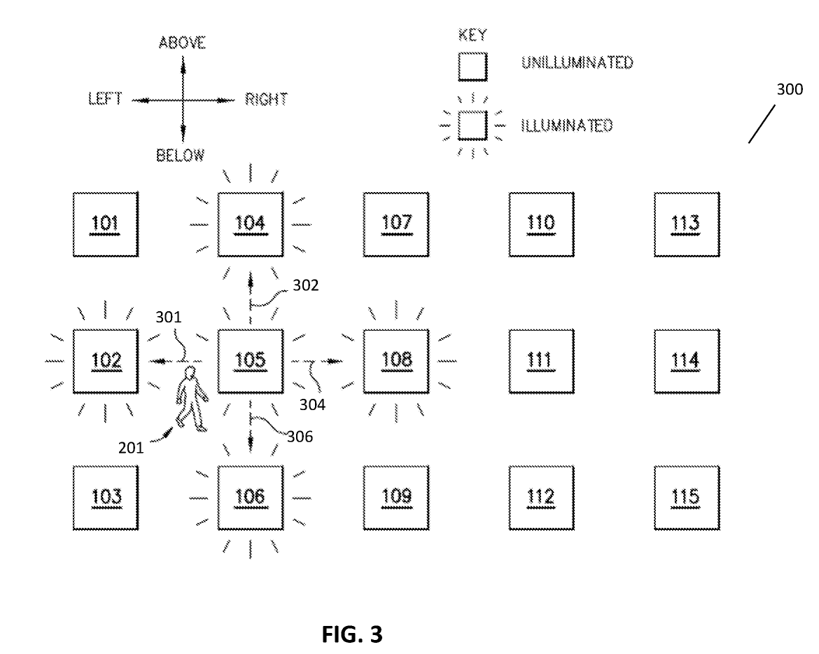

FIG. 3 is an illustration of a top view of the lighting system 200 based on a slightly different occupancy scenario. In FIG. 3, the user 201 can abruptly change movement direction as he/she travels within a luminaire matrix 300. As shown, the luminaire matrix 300 includes luminaires 101-115. In FIG. 3, the user 201 begins traveling into space illuminated by a luminaire 105. As the user 201 travels away from the area illuminated by the luminaire 102, the luminaire 105 is configured to communicate with neighboring luminaire 102 to its left.

The luminaire 105 is also configured to communicate with its neighboring luminaire 104 above, neighboring luminaire 108 to its right, and neighboring luminaire 106 below. As discussed in greater detail below, luminaires are not restricted to communicating with only their adjacent neighbors, but can communicate with a specified number of neighbors. Once the sensor associated with luminaire 105 detects the user 201, the luminaire 105 is illuminated via its controller.

The controller then triggers the communication circuit to generate and send signals to the nearby or neighboring luminaires that have been configured to communicate with luminaire 105, or other luminaires that would ordinarily be too far away to be controlled. Thus, signal 301 is sent to luminaire 102, signal 302 is sent to luminaire 104, signal 304 is sent to luminaire 108, and signal 306 is sent to luminaire 106.

Once signals 301, 302, 304, and 306 are received, the luminaires associated with these signals are illuminated via their respective controllers, although no user 201 is detected in their sensors' view angles/detection areas. Again, this provides for a well-lit space around user 201 as he/she travels across the space, while at the same time saving energy, as luminaires 101, 103, 107, and 109, 110, 111, 112, 113, 114 and 115 in the room remain unlit, switched off, or dimmed.

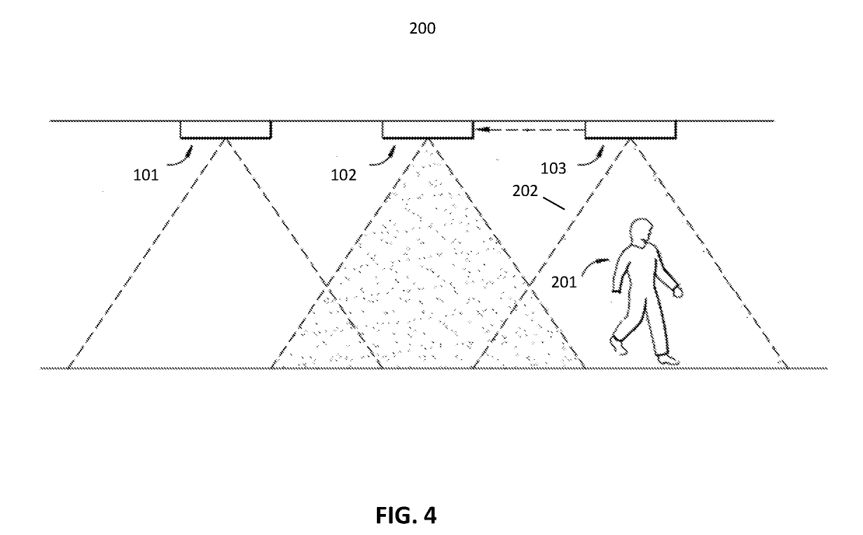

The illustrious embodiments of the present invention, however, offer yet an additional advantage over conventional systems. As noted above, certainly conventional systems are unable to compensate for variations in the speed at which the user 201 travels from one detection area to other detection areas. For example, lighting systems must be able to anticipate abrupt changes in movement by the user 201. Otherwise, abrupt changes direction or speed by the user 201 creates the possibility that he/she will exceed the system's ability to provide light coverage. Consequently, the user 201 could conceivably move into darkened areas, as illustrated below with respect to FIG. 4.

FIG. 4 is a side view illustration of a hypothetical occupancy scenario in view of the lighting system 200 of FIG. 2. In this hypothetical scenario, the user 201 could conceivably exceed the ability of the lighting system 200 to provide adequate light coverage. In FIG. 4, for example, the user 201 travels within the viewing angle 202 illuminated by the luminaire 103. In the example of FIG. 4, however, the viewing angle 202 is shown to be dark. Here, the user's movement speed has exceeded the system's ability to timely generate the signal 204 to illuminate the viewing angle 202 in anticipation of the user's arrival. In the embodiments, however, an adaptive control feature prevents the hypothetical scenario depicted in FIG. 4 from occurring.

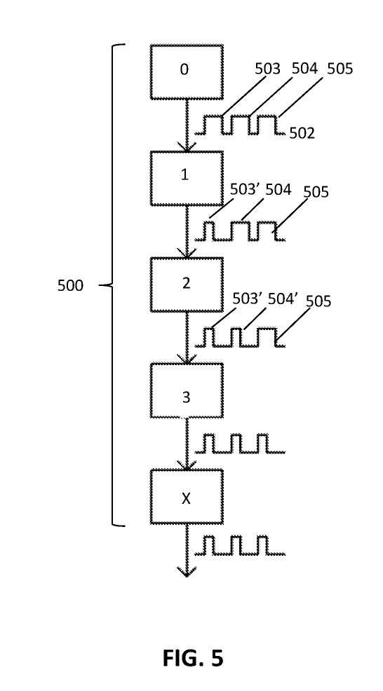

In the embodiments, as illustrated in FIGS. 5-8 below, the adaptive control feature of the lighting system 200 provides real-time tracking and compensation for abrupt movements by the user 201. The embodiments leverage the communications network formed by connections between the exemplary lighting systems 101-115, enabling motion sensing information to be communicated throughout the network in real-time. This lighting system network and real-time transmission motion sensing information ensures adaptive illumination of coverage areas where the user 201 is projected to be.

More specifically, the adaptive control feature depicted in FIGS. 5-8 below, utilizes technology that can be integrated into the lighting system 100, utilizing the same hardware associated with the lighting system 100, and the luminaires 101-115 without the need of additional wiring for connections. Thus, ease of installation of the embodiments can be preserved while, at the same time, adding the function of controlling lamps further away than one unit, and sensing motion in the system at any physical position.

In the exemplary embodiments depicted below, if a luminaire, such as the luminaire 102, receives a motion sensing notification from its neighboring luminaire 101, the luminaire 102 retransmits this notification to a specified number of its neighboring lighting systems for pre-lighting purposes. In turn, every specified lighting system retransmits this motion sensing information to a specified number of its neighbors.

The communication between lamps utilizes pulses to create a signal. A pulse is a temporary change of state in a physical condition compared to a selected baseline of that condition, which is easily detectable over the selected transmission media. For example, a pulse can represent (i) an electric voltage or current in wired communication, (ii) a frequency in radio frequency or ultrasonic communication, and (iii) presence of light in optical or infrared communication.

Upon receipt of a signal beginning with narrow pulses and ending with wide pulses, the first neighboring luminaire changes the first wide pulse to a narrow one to notify the next receiver that it's one unit away from the sensing luminaire, and retransmits the signal without time delay. On receipt of a signal consisting of only narrow pulses, the luminaire does not change it, but retransmits it without time delay. Only a narrow pulse requires no action, it only signals that some activity happened in the system. A luminaire can receive a signal consisting of only wide pulses it it's the first unit next to the sensing lamp.

This motion event can be received by a switching unit that switches the system off after inactivity during a preset time (e.g. after people went home from an office). The switching unit switches the system on at the first movement after an off-period. As the narrow pulses reach the physical boundaries of the room, they terminate. FIG. 5 is an exemplary illustration of this concept demonstrated using a single row of lamps, in accordance with the embodiments.

FIG. 5 is an exemplary illustration of a single row 500 of luminaires 0, 1, 2, 3, and X. The number of the luminaire (i.e., 0, 1, 2, 3, and X) depicted in FIG. 5 represents its distance from the unit that sensed the motion. In the example of FIG. 5, the motion begins in luminaire (0). The luminaires 0, 1, 2, 3, and X are comparable to the luminaires 102, 105, 108, 111, and 114 from the luminaire matrix 300 of FIG. 3. By evaluating a received motion sensing signal, each luminaire determines its relative location to the sensing luminaire, and responds according to this information. The motion sensing signal, as discussed in greater detail below, can represent a light level pattern around the motion can dim respective luminaires, and/or turn off the luminaires where applicable.

In FIG. 5, each of the luminaires 0, 1, 2, 3, and X has at most only two neighbors. A single row of luminaires, such as the row 500, is commonly used to illuminate building corridors, long hallways, or the like. In the illustration of FIG. 5, the luminaire (X) may or may not take any action with respect to receipt of the motion sensing signal 502.

To illustrate operation of the real-time adaptive control technique of the embodiments, the luminaire (0), of the row 500, is designated as the sensing luminaire. After movement is sensed, the luminaire (0) transmits a three pulse motion signal 502 over a specified period of time. The signal 502 includes pulses 503, 504, and 505. The neighboring luminaire (1), as the sensing luminaire receives the signal 502. The luminaire (1) then changes the first pulse 503 to a narrow pulse and retransmits the signal 502. As depicted, the first pulse 503 is retransmitted as narrow pulse 503′.

By narrowing one pulse, each of the neighboring luminaires (i.e., 1, 2, 3, X) to the luminaire (0) is able to use the signal 502 to determine precisely where the motion originated before itself. In this manner, the motion signal 502 can change the number of pulses virtually indefinitely, using the width of the pulses to identify the origin of the motion.

In the process of the luminaire (1) receiving the signal 502 from the luminaire (0), the narrow pulse 503′ indicates that the luminaire (1) received the signal 502 from its adjacent (i.e., first) neighbor, luminaire (0). In turn, luminaire (1) will retransmit the signal 502 to its neighbor luminaire (2), and so on. Eventually, all of the neighboring luminaires (i.e., 1, 2, 3, X) to the luminaire (0) will receive the signal 502. Since the first sensing luminaire (0) was the first to transmit the signal 502, it will discard the signal 502 after transmission. However, all of the luminaires (i.e., 1, 2, 3, X) neighboring the luminaire (0) are notified virtually immediately after the luminaire (0) senses motion.

Each of the neighboring luminaires (i.e., 1, 2, 3, X) also retransmits the signal 502, after changing one of the pulses 503-504 to a more narrow pulse. For example, the third luminaire (2) receives the signal 502, including the narrow pulse 503′, along with two wide pulses 504 and 505. By processing the signal 502, for example, the luminaire (1) can determine that motion originated “one” luminaire (e.g., in the luminaire (0)) before the luminaire (1).

Correspondingly, the luminaire (1) narrows “one” pulse (e.g., 503) within the signal 502 and subsequently retransmits the signal. This process notifies downstream receiver luminaire (2) (or other downstream receivers), of the signal 502, that the motion originated “two” luminaires (e.g., within luminaire (0)) before the luminaire (2). Correspondingly, the luminaire (2) narrows “one” pulse (e.g., 504) and retransmits the signal 502. The newly retransmitted signal 502 now includes narrow pulses 503′ and 504′, along with the wide pulse 505.

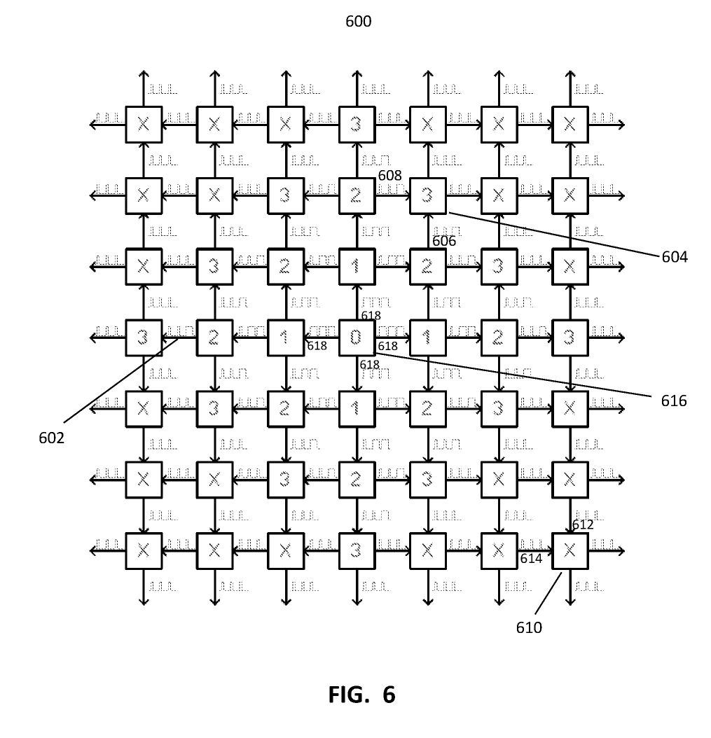

FIG. 6 is an exemplary illustration of expanding the foregoing concept in multiple directions or in 2 dimensions. For example, FIG. 6 depicts an exemplary lighting matrix 600. As in the case of FIG. 5, in the lighting matrix 600, the number of the luminaire (i.e., 0, 1, 2, 3, and X) represents their relative distance from the unit that originally sensed the motion. In the example of FIG. 6, the motion begins in luminaire (0) 616.

Communication between luminaires can be seen on wires, such as wires 602, forming connections therebetween. In the embodiments, there is substantially a zero time delay between receipt of the first motion sensing signal and retransmitting the same. By way of example, some luminaires, such as the luminaire 604, receive signals from two directions at once. These signals, however, always match in terms of the number of narrow pulses and wide pulses.

Luminaire 604 receives motion sensing signals 606 and 608. As shown, the signals 606 and 608 match, each including two narrow pulses and one wide pulse. In another example, luminaire (X) 610 simultaneously receives motion sensing signals 612 and 614, each including three narrow pulses. In the manner described above, the lighting arrangement 600 remains consistent.

More specifically, the lighting matrix 600 of FIG. 6 includes the luminaire (0) 616 at its center position. The luminaire (0) 616 transmits a three wide pulse signal 618 in four directions. All of the luminaires labeled (1) retransmit the signal 618, however, having the first pulse modified to a narrow pulse. The signal 618 is retransmitted to all of the luminaires marked with (2). The second luminaire (2) will receive the same signal from each of its neighboring luminaires marked with (1).

The luminaires marked X take no action on the sensed motion but merely retransmit the three narrow pulses. Overall, this technique creates a system where if any luminaire in the system senses the motion, it notifies its neighboring luminaires to turn on. In this manner, every luminaire in the system is notified that there is motion in the system, even though action may not be taken with respect to the motion information.

Thus, even luminaires farthest from the original motion are aware of motion in the system. With proper timing circuitry, a suitable luminaire matrix can be created for any lighting system including any amount of luminaires, along with a switching device. With a timing signal including the proper amount of pulses, each luminaire is notified, essentially in real time, whenever motion occurs anywhere in the system. For example, if motion had not occurred in the system for an hour or so, the entire system can be deactivated. In another example, the system could also be deactivated at the end of the day. As an alternative to complete deactivation, the lights could be dimmed.

Once a luminaire senses motion, it begins to transmit a specific motion sensing signal. By way of example, such a signal could include 1-8 wide pulses. The number of pulses depends on the number of luminaires desired to be controlled, in a row of luminaires, with respect to sensed motion. The present invention, however, is not limited to 1-8 pulses, nor limited to distinguishing pulses on the basis of pulse width. Any suitable number of pulses or pulse identification technique, such as pulse width modulation, could be used and would be within the spirit and scope of the present invention.

The number of pulses, for example, depends on the number of neighboring luminaires desired to be controlled in a row and in one direction, beginning with the luminaire that originally sensed the motion. On receipt of a signal consisting of only wide pulses, the luminaire changes the first one to a narrow pulse to notify the next receiver luminaire that it's the first neighbor of the sensing luminaire. The first neighbor luminaire retransmits the signal without time delay.

When receiving the signal 502 from a neighboring luminaire, the lighting system must determine whether the receiving luminaire is first the row, the second luminaire, the third luminaire, the fourth luminaire, etc. This information will aid in determining whether the respective luminaire will be powered at 20%, 40%, 60%, 80%, or similar. These percentages are programmable and can be defined by the user.

For example, these percentages can be programmed based upon whether a large light pattern is sought to be created, or whether the original sensing luminaire is closer to the light, requiring the light to be brighter. If the original sensing luminaire is father away from the light, the light intensity would be dimmer. At the furthest point from the sensing luminaire (i.e., motion), there would be a zero power level, or an equivalent thereto. Thus, determining the position from the sensing luminaire will dictate the level of dimming to apply to the lamp.

The number of pulses is also variable and user programmable. Three pulses means three luminaires next to, or away from, the sensing luminaire can be dimmed. By way of example, if three pulses are used and a user moves from one luminaire to another in the system, two luminaires can be activated in one row, or three in another row, creating a circular type pattern around the original sensing luminaire.

By way of example, if the number of pulses is set to eight, eight luminaires can be activated. Eight luminaires will create an even larger circle of motion around the original sensing luminaire. The number of pulses also determines how far away each luminaire can be from the original sensing luminaire, and how many narrow pulses are in the motion sensing signal.

In another example, if there are eight narrow pulses, this indicates the receiving luminaire is in the direct neighborhood of the original sensing luminaire and the system can light up to eight luminaires. In this eight pulse pattern example, if four narrow pulses and four wide pulses are received by the receiving luminaire, that indicates the receiving luminaire is at a fourth luminaire distance from the original sensing luminaire and that four more luminaires can be activated before the sensing signal completes its propagation through the entire system.

The timing of the changing of a wide pulse to a narrow pulse is a critical aspect of the embodiments of the present invention. More specifically, an important aspect in the embodiments is the timing associated with when, or whether, a pulse is changed from a wide pulse to a narrow pulse. If one luminaire senses motion anywhere in the system, the motion sensing signal spreads throughout the system in near real-time. The furthest luminaire from the original sensing luminaire receives information about the original motion at substantially the same time the first luminaire senses the motion.

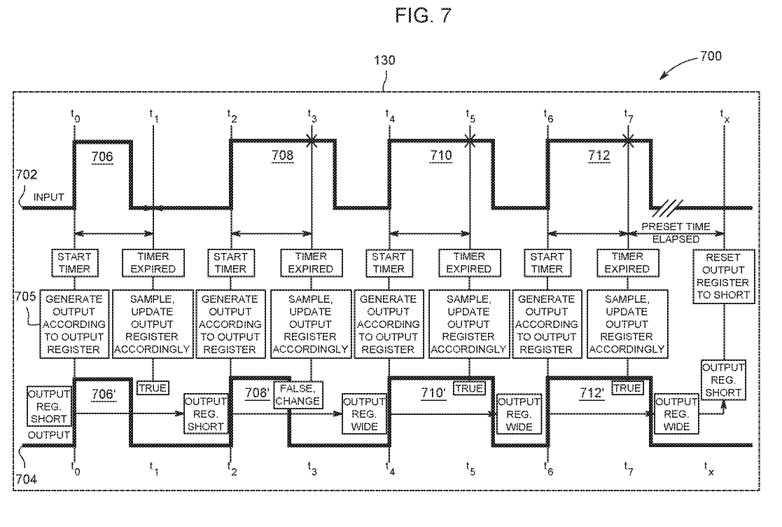

FIG. 7 is an timing diagram of an exemplary timing scheme 700 associated with the exemplary lighting luminaire matrix 600 of FIG. 6. The timing scheme 700 can be implemented within a micro-controller, such as the controller 130 of FIG. 1. The timing scheme 700 provides a way of deriving, in substantially real time, an output retransmitted motion sensing signal from an actual retransmitted input motion sensing signal.

More specifically, the timing scheme 700 provides a means of analyzing pulses of an actual motion signal input to a luminaire, retransmitted from an earlier luminaire neighbor, and determining which pulses should be narrowed as the motion signal is output from the luminaire. In the exemplary illustration of FIG. 7, a motion signal 702 is input to controller 130 of a luminaire, such as the luminaire (2) of FIG. 5. A signal 704 is produced as an output to controller 130.

Similar to the illustration of FIG. 5, luminaire (2) in FIG. 7 is assumed to a second neighbor of an original sensing luminaire (e.g., luminaire (0) of FIG. 5). As such, the motion signal 702 would have been retransmitted from an intermediate luminaire neighbor (e.g., luminaire (1)). The actual motion signal 702 includes four pulses 706, 708, 710, and 712. In a sense, widths of corresponding pulses 706′, 708′, 710′, and 712′ of motion signal 704 are predicted based upon the actual motion signal 702.

In the example of FIG. 7, the motion sensing signal 702 is received as an input to a controller an exemplary luminaire, such as the luminaire (2) of FIG. 5. In FIG. 7, however, the signal 702 is a four pulse signal, whereas the signal 502 of FIG. 5 includes only three pulses. Vertical lines in FIG. 7 are timing markers representing start and expiration times of a timer, such as the timer 132 of FIG. 1.

In FIG. 7, the timer is started at to marking the leading edge of pulse 706, and subsequently pulses 708-712. Time to also represents the start of generation of an output pulses respectively representative of the leading edges of each of corresponding retransmitted pulses 708′, 710′, and 712′. At time ti the timer expires, a value of the input signal 702 is sampled to determine whether the value is a low level or a high level, and contents of an output register 705 are set accordingly.

If the value (e.g., voltage) of the sampled input signal 702 is low at time ti, the corresponding pulse (e.g., 702) is a narrow pulse. If the value of the sampled signal 702 is high at time t₁, the corresponding pulse is a wide pulse.

The value of the output register 705 is initially set to 0 at time to because the retransmitted first pulse has to be narrow, even if the input has a wide first pulse. This occurs because when pulses are changed, they are changed from wide to narrow at retransmission.

In FIG. 7, a narrow pulse 706′ was transmitted in the output signal 704 in response to the input pulse 706. In the example of the input pulse 706, the sampled input signal 702 was a low level. If the sampled input signal 702 was a high level, as noted above, the corresponding pulse would have been wide. In the event of a wide pulse, the output register value would be set, for example, to one. In this example, the next pulse will be wide.

If the first pulse of the input signal is narrow, a narrow pulse is transmitted at the output because of the preset value of the output register 705. The output pulse is changed after sensing the first wide pulse on the input (i.e., sampling the first high level). The output register is changed a maximum of only once—at a retransmission, because narrow pulses are always on the start, wide pulses are always at the end of a signal. Such is the case in the example of the input pulse 708.

Referring back to FIG. 7, at time t2 the timer starts and the input signal 702 is sampled. The input signal 702 is a high level, corresponding to a wide pulse (i.e., pulse 708). Simultaneously, at time t₂ a leading edge of a narrow pulse 708′ is generated. At time t₃, the timer expires and the output register is updated. In the exemplary embodiment, since the output pulse is changed after sensing a first wide pulse 708 as noted above, the wide pulse 708 is changed to narrow pulse 708′ at the output. In this example, pulses 710′ and 712′ all remain wide pulses, corresponding to the wide pulses 710 and 712, since the output register is only changed once during retransmission of an input signal.

The analysis of the times t₄-t₅ and t₆-t₇, corresponding to the pulses 710 and 712 respectively, occurs in same manner described above.

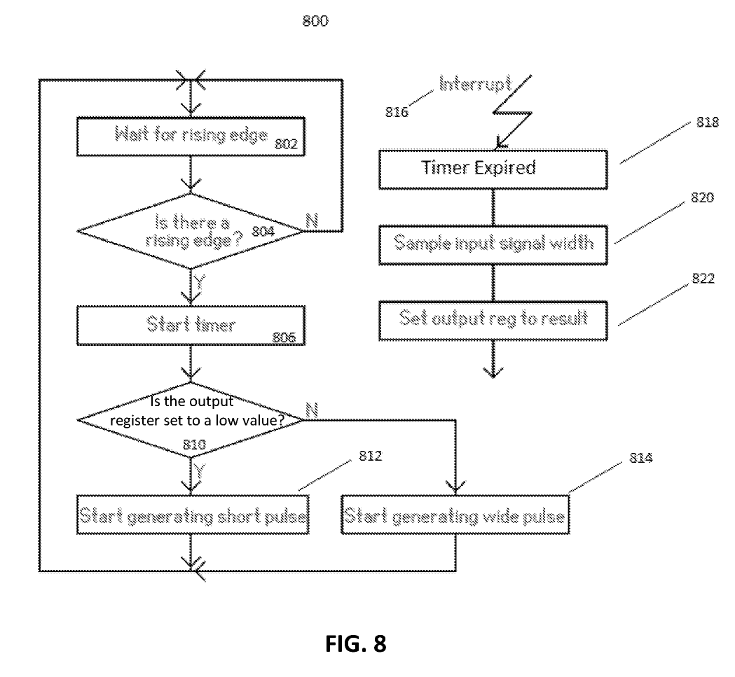

FIG. 8 is a flow chart of an exemplary method 800 of practicing an embodiment of the present invention. By way of example, the method 800 can be implemented within the ballast 118 of FIG. 1. In other embodiments, the method 800 can be implemented as a separate printed circuit board (PCB) housed within its own enclosure, or communications module. One such module can be included within each luminaire, of a luminaire matrix, such as the matrix 300. Each communication module, within the matrix, will be connected with all of the other communication modules within the matrix.

When motion is sensed within a luminaire matrix, an input signal, including only wide pulses, is transmitted in response to the sensed motion. In the exemplary method 800, the arrival of a rising edge of a first pulse of this motion sensing input signal (e.g., the signal 702) is anticipated at step 802. If a rising edge is detected in step 804 corresponding, for example, to time ti illustrated in FIG. 7, the timer is started in step 806.

Also, at time t₁, the value of the output register is analyzed to determine whether it is a low level, in step 810. If the output register value is low (i.e., corresponding to a narrow pulse), the process of generating a narrow pulse commences at step 812. If the output register value is high, the process of generating a wide pulse commences at step 814. An interrupt 816 occurs upon expiration of the timer at step 818. In step 820, the input signal is sampled to determine its width. In step 822, the output register value is set in accordance with the width of the input signal, sampled in step 820.

Alternative embodiments, examples, and modifications which would still be encompassed by the invention may be made by those skilled in the art, particularly in light of the foregoing teachings. Further, it should be understood that the terminology used to describe the invention is intended to be in the nature of words of description rather than of limitation.

Those skilled in the art will also appreciate that various adaptations and modifications of the preferred and alternative embodiments described above can be configured without departing from the scope and spirit of the invention. Therefore, it is to be understood that, within the scope of the appended claims, the invention may be practiced other than as specifically described herein.

We claim:

1. A lighting system to control illumination of a plurality of areas, the lighting system comprising:
a lighting fixture matrix including a plurality of lighting fixtures respectively located at the plurality of areas, each of the lighting fixtures including a sensor and a controller coupled with the sensor, a first sensor being configured to detect the presence of a user in a first of the plurality of areas; and
a communication circuit configured to provide communication between each of the plurality of lighting fixtures;
wherein upon detection of presence of a user in the first area, the respective controller is configured to illuminate a first of the lighting fixtures and send a signal to simultaneously trigger illumination of two or more of a remaining number of the plurality of areas.

2. The lighting system of claim 1, wherein the simultaneous illumination of the two or more remaining plurality of areas provide illumination one of the two remaining areas at a first intensity level and illumination of the second two remaining areas at a second intensity level.

3. The lighting system of claim 1, wherein one of the lighting fixtures within the lighting fixture matrix is a central lighting fixture;
wherein a first portion of the plurality of lighting fixtures is positioned to extend away from the central lighting fixture in a first direction;
wherein a second portion of the plurality of lighting fixtures is positioned to extend away from the central lighting fixture in an opposite direction; and
wherein the signal is comprised of a number of pulses matching a number of the lighting fixtures in at least one of the first and second portions of the plurality of lighting fixtures.

4. The lighting system of claim 3, wherein each portion includes a specified number of lighting fixtures; and
wherein each lighting fixture within the first and second portions is adjacent to at least one of the other lighting fixtures within the first and second portions, respectively.

5. The lighting system of claim 4, wherein the signal includes a specified number of pulses matching the specified number of lighting fixtures.

6. The lighting system of claim 5, wherein the specified number of pulses includes at least one from the group including a narrow pulse in a wide pulse.

7. The lighting system of claim 6, wherein the controller is configured to analyze widths of pulses within the specified number of pulses.

8. The lighting system of claim 6, wherein the controller is configured to (i) analyze widths of pulses within the specified number of pulses, when the signal is received by one of the specified number of lighting fixtures and (ii) modify a width of at least one of the specified number of pulses when a corresponding signal is transmitted from the one lighting fixture.

9. The lighting fixture of claim 8, wherein the modifying includes changing a wide pulse to a narrow pulse.

10. The lighting fixture of claim 8, wherein the modifying is responsive to proximity of the one lighting fixture to the central lighting fixture.

11. A method for controlling illumination of a plurality of lighting fixtures within a lighting fixture matrix via a signal having a specified number of pulses, the signal being transmitted from a central lighting fixture of the plurality, the method comprising:
sensing presence of a rising edge of the first of the pulses when the signal is received at a neighboring one of the plurality of lighting fixtures; and
determining whether a width of the first of the pulses is wide or narrow based upon a time quanta;
wherein the sensing and determining applied to a remaining number of the pulses within the multi-pulse signal.

12. The method of claim 11, wherein a first portion of the plurality of lighting fixtures is positioned to extend away from the central lighting fixture in a first direction; and
wherein a second portion of the plurality of lighting fixtures is positioned to extend away from the central lighting fixture in an opposite direction.

13. The method of claim 12, wherein each portion includes a specified number of lighting fixtures; and
wherein each lighting fixture within the first and second portions is adjacent to at least one of the other lighting fixtures within the first and second portions, respectively

14. The method of claim 12, wherein the controller is configured to modify a width of at least one of the specified number of pulses when a corresponding signal is transmitted from the neighboring one of the plurality of lighting fixtures.

15. The method of claim 14, wherein the specified number of pulses matches a number of the lighting fixtures in at least one of the first and second portions of the plurality of lighting fixtures.

16. The method of claim 15, wherein the modifying includes changing a wide pulse to a narrow pulse.

17. The method of claim 16, wherein the modifying is responsive to proximity of the one lighting fixture to the central lighting fixture.

18. The method of claim 17, wherein the signal comprises an optical, infrared, ultrasonic, radio frequency, or hard-wired signal.

19. The method of claim 11, wherein the determining and sensing occur in real time.

20. The lighting fixture of claim 1, wherein the signal comprises an optical, infrared, ultrasonic, radio frequency, or hard-wired signal.
